(19) United States
(12) Patent Application Publication
(10) Pub. No.: US 2006/0207684 A1
(43) Pub. Date: Sep. 21, 2006

(54) Wood chipper

(76) Inventor: Paul Polt, Omaha, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 11/064,555

(22) Filed: Feb. 24, 2005

(51) Int. Cl. B27C 1/00

(52) U.S. Cl. 144/162.1

(57) ABSTRACT

A wood chipper comprising a pair of horizontally spaced-apart upstanding end walls having a plurality of rotatable shafts extending therebetween. The shafts are arranged so that they define a semi-circular configuration when viewed from the ends thereof and which define an open upper ended wood receiving area between the first and second end walls. A plurality of horizontally spaced-apart chipping discs are mounted on the shafts between the side walls and have chipping teeth extending radially therefrom. The chipping discs are offset or staggered on the shafts so that the chipping discs of one shaft may extend inwardly between the chipping discs on adjacent shafts. When wood is placed in the wood receiving area, the weight of the wood causes the wood to be brought into engagement with the rotating cutting discs to chip the same.

### BACKGROUND OF THE INVENTION

1. Field of the Invention

This invention relates to wood chipper and more particularly to a wood chipper having a novel array or configuration of rotatable shafts which have spaced-apart chipping discs mounted thereon for rotation therewith.

2. Description of the Related Art

There have been many types of wood chippers previously provided for chipping branches, trunks, etc., to as to reduce the volume thereof and so to be able to provide wood chips which may be used for ground cover, mulch, etc. The vast majority of the prior art wood chippers include a horizontally disposed chipper wheel or drum which is rotatable about a horizontal axis and which has chipping teeth or knives protruding radially therefrom which engage the wood coming into contact therewith to chip the same. Although many of the conventional wood chippers have met with some success, it is believed that there is a more efficient and safer way to chip wood than that previously provided.

### SUMMARY OF THE INVENTION

A wood chipper is provided which includes first and second upstanding walls which are horizontally spaced-apart and which each has an upper end, a lower end, a first side edge and a second side edge. A plurality of generally horizontally disposed rotatable shafts have their opposite ends rotatably mounted in the first and second walls so as to rotatably extend therebetween. The shafts are disposed with respect to each other so as to define a generally semi-circular configuration, when viewed from the ends thereof, with the semi-circular configuration of the shafts providing a wood receiving area between the first and second walls having an open upper end thereof. Each of the shafts has a plurality of horizontally spaced-apart chipping discs mounted thereon for rotation therewith. The chipping discs on the shafts are offset with respect to the chipping discs on the adjacent shaft so that the chipping discs of one shaft extend inwardly between the chipping discs on adjacent shafts. The rotation of the shafts causes the chipping discs to engage wood placed within the wood receiving area and to chip the same with the wood chips being discharged from the wood receiving area. Preferably, some of the shafts are rotated in an opposite direction with respect to the direction of rotation of other shafts to achieve an efficient chipping action. A wood chip guide is positioned between the first and second walls on the discharge side of the shafts to guide wood chips passing from the chipping discs. Preferably, a wood chip conveyor is in communication with the discharge side of the chipping discs. Each of the chipping discs has a periphery which has a plurality of spaced-apart chipping teeth extending outwardly therefrom. Preferably, the chipping teeth are adjustably threadably secured to the chipping discs.

In use, the wood to be chipped is simply dropped into the open upper end of the wood receiving area and the weight of the wood causes the wood, such as branches or trunks, to be chipped by the rotating chipping teeth. The rotational force of the chipping teeth and gravity causes the chips to be discharged from the wood receiving area into the guide and preferably to a conveyor.

It is therefore a principal object of the invention to provide an improved wood chipper.

A further object of the invention is to provide a wood chipper which includes a plurality of horizontally extending rotatable shafts which define a semi-circular wood receiving area between a pair of side walls.

Still another object of the invention is to provide a wood chipper of the type described above wherein the chipping discs on the shafts are offset with respect to the chipping discs on adjacent shafts so that the cutting discs of one shaft can extend inwardly between the cutting discs of the adjacent shafts.

Still another object of the invention is to provide a wood chipper which is safe to use.

Still another object of the invention is to provide a wood chipper including length adjustable teeth which may be further extended from the chipping discs as the teeth become worn.

These and other objects will be apparent to those skilled in the art.

### BRIEF DESCRIPTION OF THE DRAWINGS

FIG. 1 is a rear perspective view of the wood chipper of this invention;

FIG. 2 is a rear elevational view of the wood chipper of this invention;

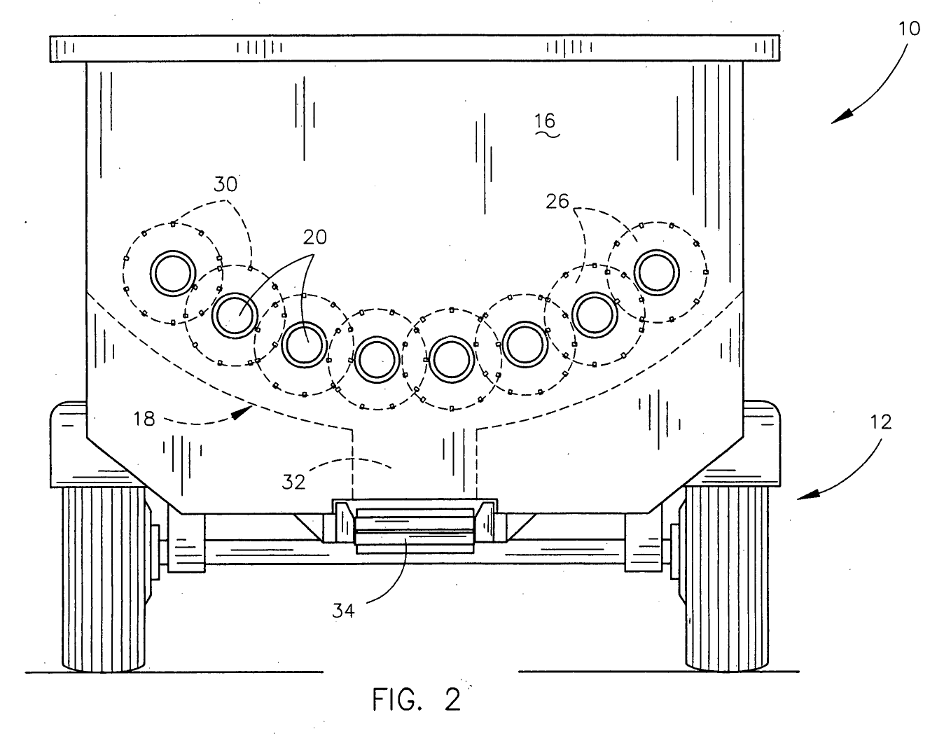

FIG. 3 is a side elevational view of the wood chipper of this invention;

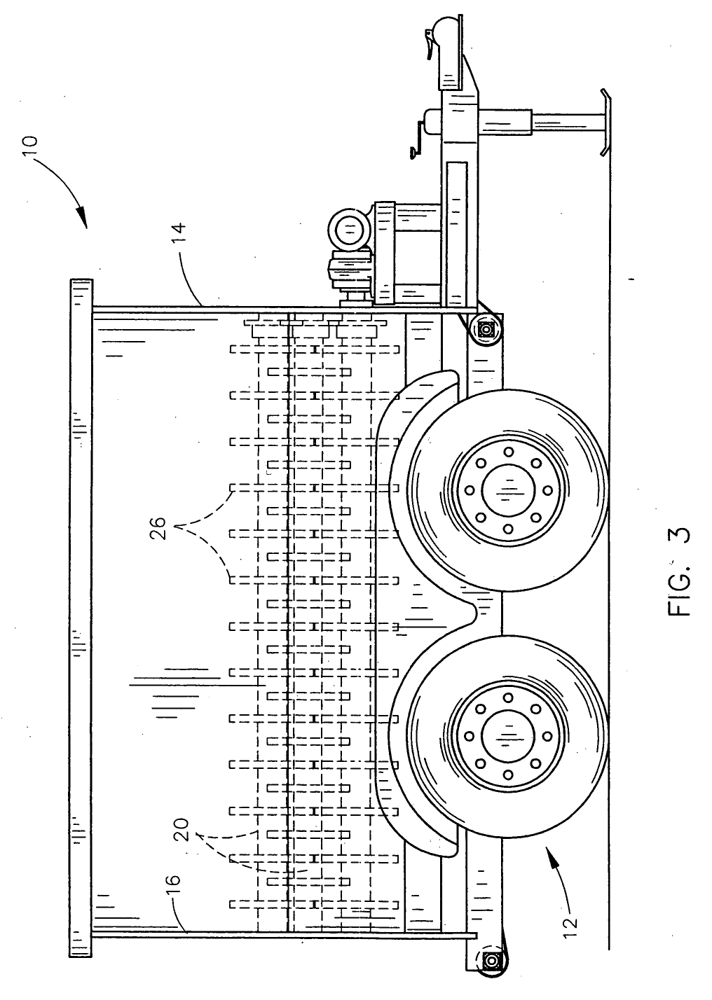

FIG. 4 is a partial sectional view of the wood chipper of this invention;

FIG. 5 is a partial exploded perspective view of a pair of the rotatable shafts and chipping discs of the invention; and

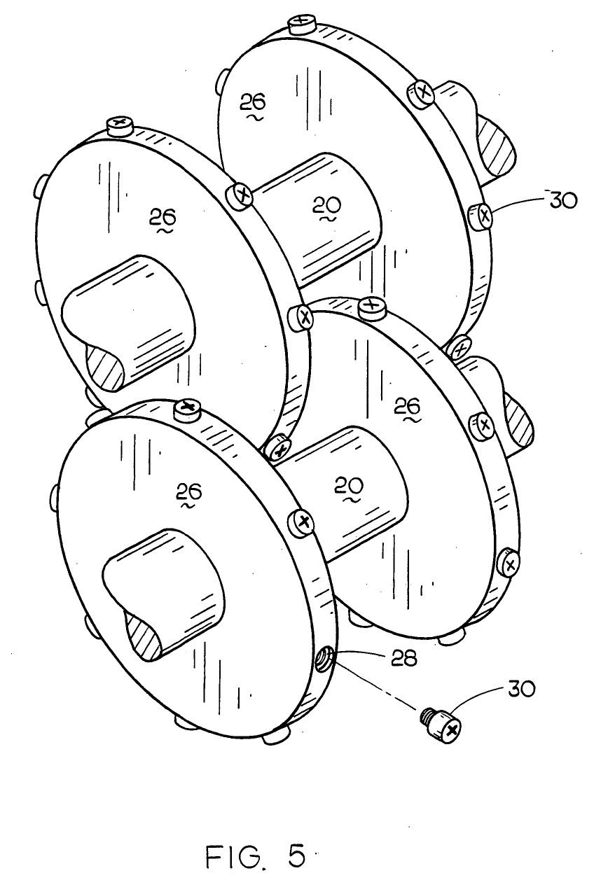

FIG. 6 is a partial sectional view of the wood chipper of this invention.

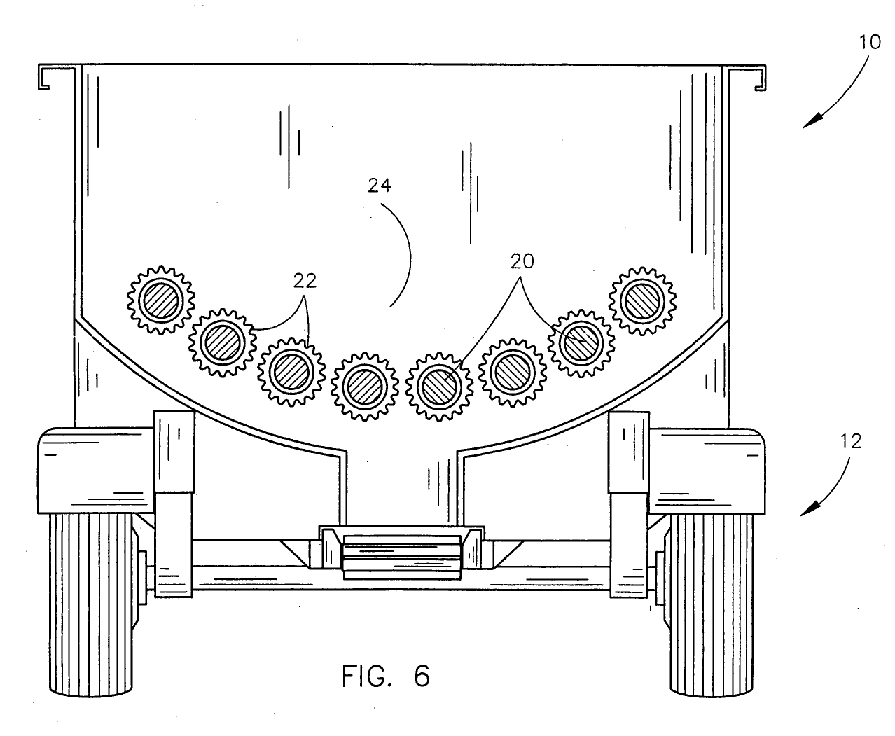

### DETAILED DESCRIPTION OF THE INVENTION

The wood chipper of this invention is referred to generally by the reference numeral 10 and is preferably mounted on a wheeled trailer or frame generally referred to by the reference numeral 12. A pair of upstanding end walls or supports 14 and 16 are mounted on the frame 12 and which have a generally U-shaped body 18 extending therebetween which defines a chip guide which will be described in more detail hereinafter. Preferably, end walls 14 and 16 are eight feet wide and have a height of six feet.

A plurality of rotatable shafts 20 have their opposite ends rotatably mounted in end walls 14 and 16. Although the drawings illustrate that sprockets or gears 22 are mounted on the shafts 20 rearwardly of the front end wall 14, the shafts 20 could be completely extended through the wall 14 so that the sprockets or gears are positioned forwardly of wall 14.

The rotatable shafts 20 are secured to the end walls 14 and 16 in a generally semi-circular configuration as viewed from the ends thereof. As viewed from the upper side of the apparatus, the shafts 20 define a generally U-shaped or semi-circular shaped wood receiving area 24. Each of the shafts 20 has a plurality of horizontally spaced-apart chipping discs 26 secured thereto by welding or the like. The chipping discs 26 on the shafts 20 are offset so that the chipping discs 26 on one shaft may extend inwardly between the chipping discs 26 on an adjacent shaft, as seen in the drawings.

Although many types of cutting surfaces may be provided on the peripheries of the chipping discs 26, it is preferred that a plurality of radially spaced-apart, internally threaded openings 28 be provided thereon which threadably receive chipping teeth 30 therein. As the chipping teeth 30 wear, they may be threadably moved with respect to the threaded opening 28 so that the outer end thereof protrudes outwardly from the chipping disc 26 at the proper amount.

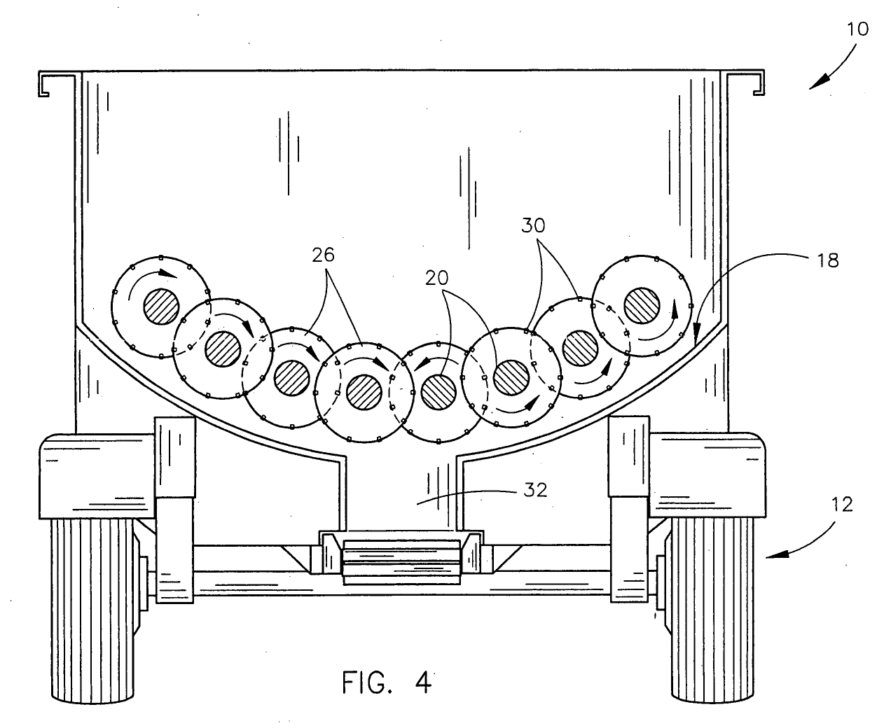

The sprockets or gears 22 are operatively connected to suitable power driven chains or belts in a fashion so that the shafts 20 at one side of the array will be rotated in a counterclockwise direction and so that the shafts at the other side of the shaft array will be rotated in a counterclockwise direction as illustrated by the arrows in FIG. 4. Obviously, the belts or chains connecting the sprockets or gears 22 will be connected to a suitable gearbox driven by a suitable power source in conventional fashion. Although the above-identified direction of rotation of the shafts is the preferred direction, the direction of rotation of the shafts may be varied depending upon the product being chipped, the weight of the product, etc.

The chip guide 18 extends between end walls 14 and 16 at the discharge side of the chipping discs 26 so that the chips falling or driven from the wood receiving area 24 will fall onto the chip guide 18 and pass through the discharge opening 32 and then be brought into communication with a chip conveyor 34 or the like.

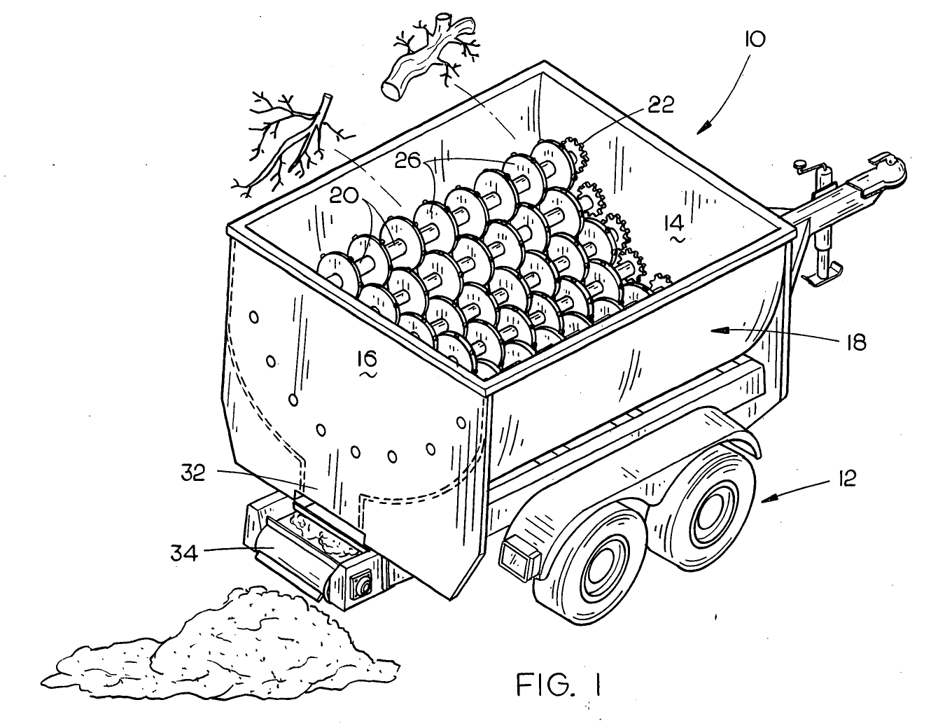

In use, the wood chipper 10 is powered to cause the rotation of the chipping discs as previously described. A worker may then simply toss or throw the wood to be chipped into the wood receiving area 24 (FIG. 1) and the weight of the wood will cause the wood to move into engagement with the rotating chipping discs 26 with the chipping teeth 30 thereon to remove chips from the wood and deliver the same to the chip guide or chute 18 for subsequent delivery to the chip conveyor 34. As stated, as the chipping teeth 30 wear, they may be threadably moved outwardly from their threaded openings 28 so that the proper amount of exposure of the chipping teeth will be provided.

Thus it can be seen that a novel wood chipper has been described which is extremely efficient and which is believed to be safer than that previously provided due to the unique design of the open-ended upper end of the wood receiving area. Although the chipper of this invention is ideally suited for chipping wood, the chipper may also be used to chip other products such as concrete, asphalt, etc.

Thus it can be seen that the invention accomplishes at least all of its stated objectives.

I claim:

1. A wood chipper, comprising:
a first upstanding wall;
a second upstanding wall spaced from said first wall;
a plurality of generally horizontally disposed rotatable shafts having opposite ends rotatably mounted on said first and second walls so as to rotatably extend therebetween;
said shafts being disposed with respect to each other so as to define a generally semi-circular configuration when viewed from the ends thereof;
said semi-circular arrangement of said shafts providing a wood receiving area between said first and second walls having an open upper end;
each of said shafts having a plurality of horizontally spaced-apart chipping discs mounted thereon for rotation therewith;
said chipping discs on said shafts being offset with respect to the chipping discs on the adjacent shaft so that the chipping discs of one shaft extend inwardly between the chipping discs on adjacent shafts;
the rotation of said shafts causing said chipping discs to engage wood placed within said wood receiving area and to chip the same with the wood chips falling downwardly from the said wood receiving area.

2. The wood chipper of claim 1 wherein some of said shafts are rotated in an opposite direction with respect to the direction of rotation of other shafts.

3. The wood chipper of claim 1 wherein a wood chip guide is positioned between said first and second walls beneath said chipping discs to guide wood chips passing from said chipping discs.

4. The wood chipper of claim 1 wherein a wood chip conveyor is in communication with the discharge side of said chipping discs.

5. The wood chipper of claim 1 wherein each of said chipping discs has a periphery and wherein a plurality of spaced-apart chipping teeth extend outwardly therefrom.

6. The wood chipper of claim 5 wherein said chipping teeth are adjustably threadably secured to said chipping discs.

7. A chipper, comprising:
a first upstanding wall;
a second upstanding wall spaced from said first wall;
a plurality of generally horizontally disposed rotatable shafts having opposite ends rotatably mounted on said first and second walls so as to rotatably extend therebetween;
said shafts being disposed with respect to each other so as to define a generally semi-circular configuration when viewed from the ends thereof;
said semi-circular arrangement of said shafts providing a product receiving area between said first and second walls having an open upper end;
each of said shafts having a plurality of horizontally spaced-apart chipping discs mounted thereon for rotation therewith;
said chipping discs on said shafts being offset with respect to the chipping discs on the adjacent shaft so that the chipping discs of one shaft extend inwardly between the chipping discs on adjacent shafts;
the rotation of said shafts causing said chipping discs to engage the product placed within said product receiving area and to chip the same with the chips therefrom falling downwardly from the said product receiving area.

8. The chipper of claim 7 wherein some of said shafts are rotated in an opposite direction with respect to the direction of rotation of other shafts.

9. The chipper of claim 7 wherein a chip guide is positioned between said first and second walls beneath said chipping discs to guide chips passing from said chipping discs.

10. The chipper of claim 7 wherein a chip conveyor is in communication with the discharge side of said chipping discs.

11. The chipper of claim 7 wherein each of said chipping discs has a periphery and wherein a plurality of spaced-apart chipping teeth extend outwardly therefrom.

12. The chipper of claim 11 wherein said chipping teeth are adjustably threadably secured to said chipping discs.
